(19) United States
(12) Patent Application Publication
(10) Pub. No.: US 2011/0236863 A1
(43) Pub. Date: Sep. 29, 2011

(54) Hand Songs® word-icon-action method and reading system

(76) Inventor: Kathleen Marie Ermitage, Evanston, IL (US)

(21) Appl. No.: 12/661,822

(22) Filed: Mar. 25, 2010

(51) Int. Cl. G09B 17/00

(52) U.S. Cl. 434/178

(57) ABSTRACT

The Hand Songs® Word-Icon-Action Method and Reading System supplements the teaching of reading, language development, and language expression. Each icon/symbol represents a word, group of words, or phrase. The Hand Songs® icons are line art. The face is uniform and standard throughout the system. Hand Songs® icons also include pictures for hands and other body parts.

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING COMPACT DISC APPENDIX

Not Applicable

### BACKGROUND OF INVENTION

Hand Songs® Word-Icon-Action Method and Reading System is an educational process. The icons in the system refer to actions, gestures, or “finger plays,” which are frequently used in reading to young children and in special educational settings. The actions, gestures, or “finger plays,” are common ways to use your hands, facial gestures, and other body movements to show action in reading a text or other printed matter. Each icon in the system refers to a single word, group of words, or a phrase. The icons build word recognition, vocabulary, and language expression in English, Spanish, French, Hindi, Mandarin, Italian, Russian, or any other written language. The icons may be used in sentence formation. The actions, gestures, or “finger plays,” (represented by the icons) are a form of demonstration.

### BRIEF SUMMARY

Hand Songs® Word-Icon-Action Method and Reading System is supplementary to the teaching of reading, language development, and language expression. The icons/symbols represent “finger plays” that are commonly used in pre-K classrooms, daycares, and educational environments for children ages 3-5. The icons/symbols are also applicable in special education settings (classrooms, after-school programs) in which language development and expression is in need of modeling.

### BRIEF DESCRIPTION OF SEVERAL VIEWS OF THE DRAINING

Each drawing below refers to a word, group of words, or phrase. The drawings enclosed within this patent application are those developed to date. Additional drawings for words, group of words, or phrases will be added to this system over time.

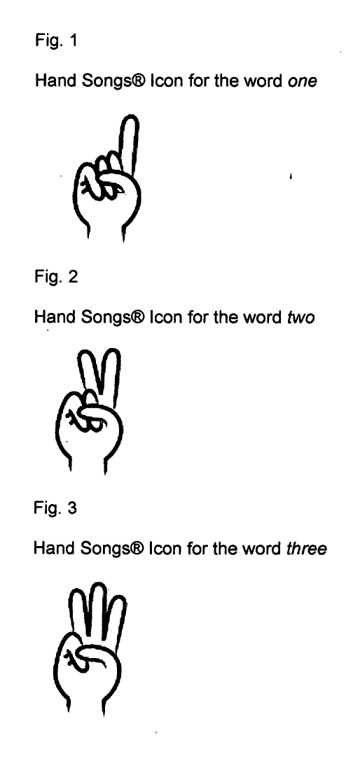

FIG. 1 illustrates the Hand Songs® icon for the word and gesture for the number 1 (one).

FIG. 2 illustrates the Hand Songs® icon for the word and gesture for the number 2 (two).

FIG. 3 illustrates the Hand Songs® icon for the word and gesture for the number 3 (three).

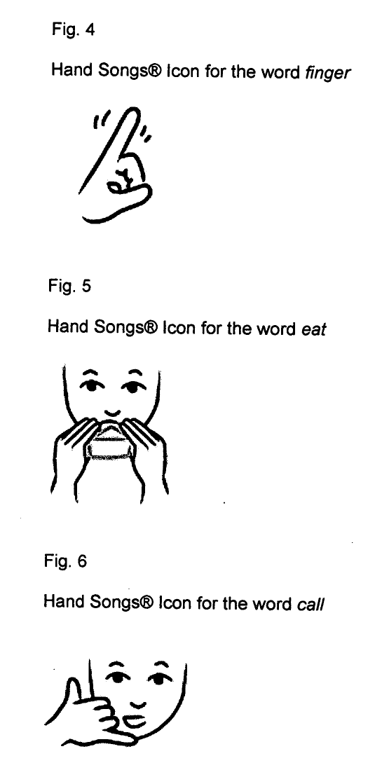

FIG. 4 illustrates the Hand Songs® icon for the word finger.

FIG. 5 illustrates the Hand Songs® icon for the word eat.

FIG. 6 illustrates the Hand Songs® icon for the word call.

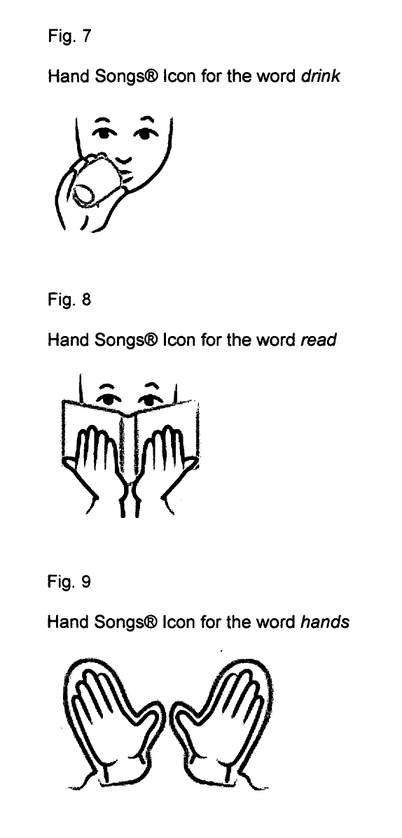

FIG. 7 illustrates the Hand Songs® icon for the word drink.

FIG. 8 illustrates the Hand Songs® icon for the word read

FIG. 9 illustrates the Hand Songs® icon for the word hands.

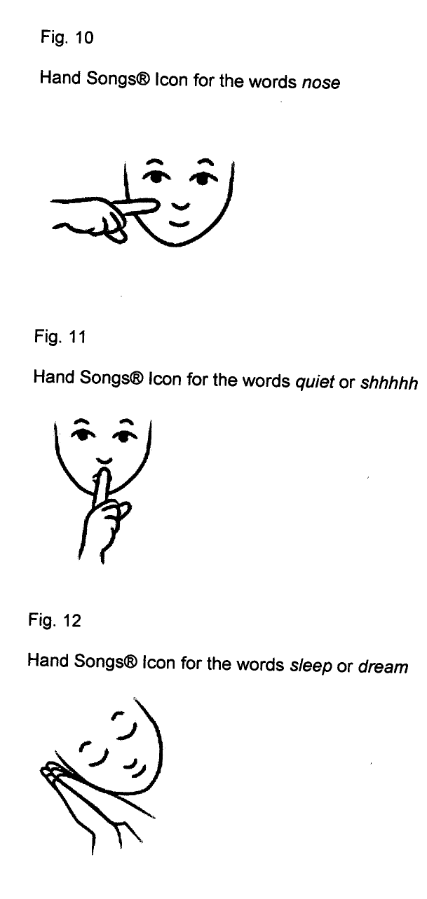

FIG. 10 illustrates the Hand Songs® icon for the word nose.

FIG. 11 illustrates the Hand Songs® icon for the word quiet or the sound shhhh.

FIG. 12 illustrates the Hand Songs® icon for the words sleep or dream.

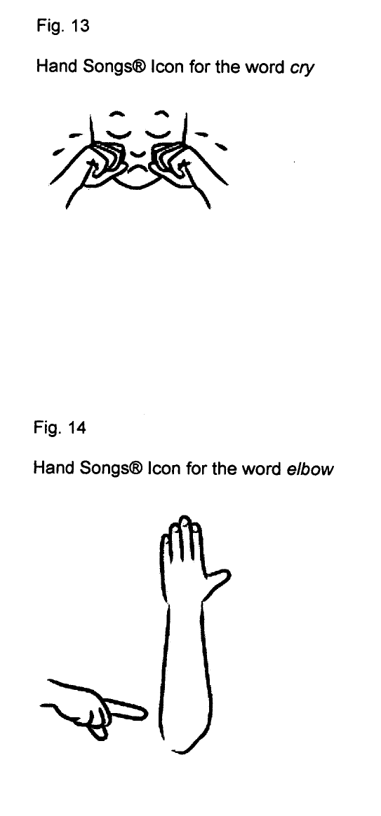

FIG. 13 illustrates the Hand Songs® icon for the word cry.

FIG. 14 illustrates the Hand Songs® Icon for the word elbow.

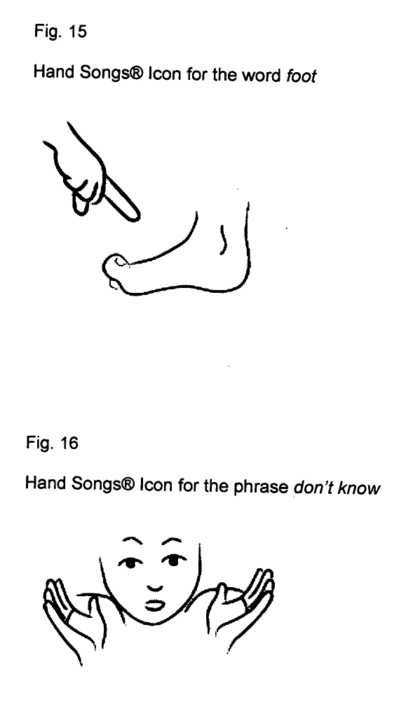

FIG. 15 illustrates the Hand Songs® Icon for the word foot.

FIG. 16 illustrates the Hand Songs® Icon for the phrase don't know.

### DETAILED DESCRIPTION OF INVENTION

Hand Songs® Word-Icon-Action Method and Reading System is a system and method for building literacy, language development, and language expression by using hand gestures, facial expressions, body movements, or “finger plays.” The system includes pictorial icons that represent gestures, facial expressions, body movements, or “finger plays.” Each pictorial icon also corresponds to a word, group of words, or a phrase. The simultaneous reading of a selected word and the pictorial icon is a method that connects the word, group of words, or phrase to the gesture, facial expression, body movement, or “finger play.” The connection of the word, group of words, or phrase with the icon prompts the reader or readers to express the word with a gesture or other physical action. The icon and gesture, facial expression, body movement, or “finger play” reinforces the recognition of the word. The association of the icon with the word, group of words, or phrase with the gesture, facial expression, body movement, or “finger play” builds vocabulary development and language expression. The system of icons, gestures, and other physical actions comprises an educational system for building literacy, language development, and language expression.

1. An educational process of using symbols to supplement the teaching of reading and vocabulary development and language expression comprising the steps of:
a. reading a text (literature; poem; song; rhyme; prose);
b. looking at a graphic element (symbol/icon) that represents a gesture, facial expression, body movement, or “finger plays”;
c. making the gesture, facial expression, body movement, or “finger plays” using your hands, face, other body parts; and
d. connecting the gesture and symbol/icon with the representative word, words, or phrase in English, Spanish, French, Hindi, Mandarin, Italian, Russian, or any other written language.
